(19) United States
(12) Patent Application Publication
(10) Pub. No.: US 2013/0299618 A1
(43) Pub. Date: Nov. 14, 2013

(54) CRUSHING BODY AND METHOD OF MAKING THE SAME

(71) Applicant: David Sharman, Fleetwood, PA (US)

(72) Inventor: David Sharman, Fleetwood, PA (US)

(73) Assignee: FLSmidth A/S, Valby (DK)

(21) Appl. No.: 13/977,136

(22) PCT Filed: Dec. 29, 2011
(86) PCT No.: PCT/US11/67727

§ 371 Date: Jun. 28, 2013

Related U.S. Application Data
(60) Provisional application No. 61/427,821, filed on Dec. 29, 2010.

(51) Int. Cl. B02C 23/00

(52) U.S. Cl. CPC B02C 23/00
USPC 241/300; 29/525.01; 29/525.13; 29/525.14

(57) ABSTRACT

A crushing body includes a wear body, inserts positioned in channels of the wear body, a mounting body positioned adjacent to the inserts and fasteners inserted into the mounting body to connect the mounting body to the inserts, the wear body, or both the inserts and the wear body. Preferably, the inserts are positioned so that a portion of each of the inserts is within the wear body and a base portion is adjacent to or engages the mounting body. Crushing devices such as mills, and crushers may utilize embodiments of the crushing body.

### FIELD OF THE INVENTION

The present invention relates to crushing bodies for the comminution of material such as ore, rock, agglomerated material, minerals, stone, material used in the making of cement, minerals and other types of material. Examples of crushing bodies include rollers of roller mills that are configured to grind material or crushing surfaces of crushing devices, such as crushers, grinders, presses, roller presses, jaw crushers, gyratory crushers, vertical grinding mills, other mills or other devices configured to crush material or comminute material. Preferably, the crushing body is configured to have a wearable surface that defines an autogenous layer or semi-autogenous layer.

### BACKGROUND OF THE INVENTION

Crushing devices used to comminute material often include a crushing body or multiple crushing bodies that are configured to impact material to crush or grind the material. Often the crushing bodies are configured to grind the material between a surface of the crushing body and the surface of another crushing body such as a roller, a table, a wall, or another surface. Examples of such crushing devices may be appreciated from U.S. Pat. Nos. 252,755, 278,272, 412,558, 1,225,061, 1,589,302, 3,955,766, 3,964,717, 4,369,926, 4,485,974, 4,582,260, 4,848,683, 5,203,513, 5,823,450, and 6,523,767 and U.S. Patent Application Publication No. 2009/0218429.

Examples of crushing bodies may also be appreciated from previously filed U.S. patent application Ser. Nos. 12/766,110, 12/873,596 and 12/892,975, which disclose crushing devices that utilize crushing bodies that have wearable surfaces such as, for example, dies, rollers, anvils and tables that help comminute material. The owner of the rights in the present application also owns the rights to U.S. patent application Ser. Nos. 12/766,110, 12/873,596 and 12/892,975. The entirety of U.S. patent application Ser. Nos. 12/766,110, 12/873,596 and 12/892,975 are incorporated by reference herein.

Crushing bodies often include a wearable surface. The wearable surface often experiences wear as material is crushed by the crushing body. As the crushing body experiences wear, portions of the wearable surface may erode or become broken during use and subsequently requires replacement or repair.

Some wearable surfaces used in crushing devices include hexagonal tiles, such as the tiles disclosed in U.S. Pat. No. 5,755,033. A tiled surface is adhered directly to a roll surface base material and can be arranged with or without gaps between the tiles. The tiles are usually relatively thin and made of materials harder than the base material. During use, the tiles can break free from the base material when crushing material, which may expose the base material to the grinding process and thereby damage the base material. The tiles must be reattached or replaced to repair the roll surface and prevent damage to the base material. However, because the base material is often exposed to grinding forces, the reattachment or replacement of any missing tile may result in a less secure attachment than what was initially provided, which may make the tile more likely to again break free during use.

Other wear surfaces may include inserts that are attached to a roll body. An insert may be attached to a roll body by glue or an adhesive or explosion welding. Rollers with such a wear surface often experience insert cracking, breaking or fall out because the glue or adhesive fails to provide a sufficient bond with a roll body to withstand the extreme pressures associated with grinding and crushing material.

Other wearable surfaces used in crushing devices may be appreciated from U.S. Pat. No. 5,269,477. Such wearable surfaces include inserts embedded in a surface of a cylindrical press roll. A binding ring may be used to attach the inserts to the press roll. Once the relatively thin binding rings of such rollers are depleted due to wear, the inserts are no longer mechanically retained within a roll body during use so that only a bond provided by glue or other adhesive may be the only means of retaining the inserts within the roller. As a result, the inserts may fall out or become damaged. Replacement of such inserts may be very time consuming if binding rings are again used to reattach the new inserts.

A new crushing body is needed that may incorporate a more stable and reliable means of attachment, support and retention of inserts. Embodiments of the crushing body preferably permit sufficient attachment of the inserts to the crushing body to increase the stability and life of the crushing body. The inserts of such crushing bodies are preferably secured sufficiently to significantly reduce, if not completely reduce, the occurrences of insert breakage or other insert damage, which can help reduce maintenance costs and downtime for crushing devices that use embodiments of the crushing body.

### SUMMARY OF THE INVENTION

A method of making a crushing body for a crushing device, the crushing body, and the crushing device are provided herein. Embodiments of the method may provide for making a crushing body that can be used in crushing devices that may use a combination of mechanical and chemical attachment to be utilized for attaching inserts to the crushing body to improve the stability and ultimately the life of the inserts. Inserts may be securely attached to a crushing body to help prevent insert damage to occur when a crushing body is used to comminute material such as ore, rock, stone, agglomerated material, material used to make cement, materials to make minerals, or other materials.

A method of making a crushing body for a crushing device may include forming a wear body, forming a mounting body, positioning inserts in channels formed in the wear body, positioning the mounting body adjacent to a base portion of each of the inserts, and inserting fasteners into the mounting body to connect the mounting body to at least one of the inserts and the wear body.

Preferably, embodiments of the method may form a crushing body that is able to provide multiple fastening methods to the inserts that won't deplete or wear, which can help mitigate or avoid insert damage that could occur when the crushing body is used to crush material. For instance, the inserts may be interlocked between the wear body and mounting body portions of the crushing body and also glued to the wear body, the mounting body, or both when positioned in the channels of the wear body.

Embodiments of the method may permit inserts to be pushed, pulled, screwed, or pressed through or into the channels of the wear body through a side or surface of the wear body that is on the crushing surface of the wear body or opposite the crushing surface of the wear body. Mechanical attachment provided by fasteners or a fastening mechanism may also be provided adjacent to the side of the wear body that is opposite the crushing surface of the wear body. The mechanical attachment of the inserts may help retain the inserts even if a portion of the insert is fracture or broken so that the whole insert does not fall out from the wear body. Moreover, the use of glue or other bonding agent may help keep the inserts affixed within the wear body and help better distribute loading the inserts experience to the wear body, which can help increase the life of the inserts. It should be appreciated that mechanically loading the inserts while also incorporating the chemical bonding via glue or another adhesive may assist in the load distribution and stabilization of the inserts within the crushing body.

Of course, some embodiments of the method may utilize the insertion of fasteners into the mounting body to connect the mounting body to at least one of the inserts and the wear body. For example, some fasteners may be inserted into the mounting body to fit within apertures such as holes or bores that are in the inserts and other fasteners may be inserted into the mounting body to fit within apertures of the wear body. In yet other embodiments of the method, the fasteners may only be inserted into the wear body and the mounting body or only be inserted into the inserts and the mounting body.

Preferably, the inserts are harder than the wear body. The inserts, wear body and mounting body may be composed of metal, non-metal material, a composite material, or a ceramic material. For instance, the wear body may be composed of metal or a composite material, the inserts may be composed of a metal or a ceramic material, and the mounting body may be composed of a metal, an alloy, or a composite material.

In some embodiments, the wear body may be configured to have a plurality of material dams. The material dams may be positioned on the crushing surface of the wear body to help retain material and prevent material from flowing away from crushing forces being applied to the material. For instance, if the crushing body is a roller, the material dams may prevent material from flowing in an axial direction away from crushing forces being applied by the roller rotating along an axis. It should be appreciated that the axis may define the axial directions. The material dams may be affixed to the wear body such that the material dams are replaceably attached by removing one or more fasteners to replace a worn or damaged material dam with a new material dam. The fasteners may be preferably removed without having to disconnect the mounting body from the wear body or disconnect the crushing body from an axle or other component of a crushing device when the crushing device is positioned in a crushing circuit or other material processing facility.

In some embodiments of the method, the mounting body may be positioned such that the mounting body engages a portion of the base portion of each of the inserts. For example, the mounting body may have recesses formed thereon to receive the portion of the base portion of each of the inserts. As another example, the mounting body may have bosses formed thereon to engage and support the portion of the base portion of each of the inserts. The portion of the base portion may be a top or bottom of the base portion.

Embodiments of the method may also include the use of sleeves. For instance, the inserts may be positioned into sleeves so that each of the inserts is at least partially surrounded by a respective one of the sleeves. The inserts may be positioned in the sleeves prior to positioning the inserts and sleeves into the wear body such that the sleeves may be positioned in the wear body when the inserts are positioned in the wear body. Alternatively, the sleeves may first be positioned in the channels of the wear body and thereafter the inserts may be positioned in the sleeves. Moreover, the inserts may be positioned in the wear body prior to the sleeves and the sleeves subsequently inserted into the wear body. It should be appreciated that positioning the inserts into the sleeves for such embodiments also positions the inserts into the channels of the wear body since the sleeves are already in the channels.

In some embodiments of the method, the mounting body may also be welded, hot isostatic pressed or bonded to the wear body. The welding, hot isostatic pressing, or bonding may occur after the fasteners are inserts or before the fasteners are inserted.

In one embodiment of the method, a fastening member may be attached to the wear body so that the fastening member is positioned between the wear body and the mounting body. The fasteners may be positioned in the fastening member to connect the wear body to the mounting body. The fastening member may be an integral or separate portion of the wear body, mounting body, and/or other portion of the crushing body.

The mounting body may have one or more profiles formed thereon that are configured to interlock with a component of a crushing device such as an axle for a roller or a base portion of a die of a mill. For example, the one or more profiles may include grooves, bores, other apertures, protrusions, projections or combinations thereof that help define a particular shape for a portion of the mounting body that is sized and configured to mate with a portion of the component of the crushing device.

It should be understood that the crushing body that is formed may have any of a number of shapes or configurations. For instance, the crushing body may be a roller, a sleeve, a segment of a roller, a segment of a sleeve, a crushing surface of a table, an anvil, a crushing surface of an anvil, a die, a liner, or a head of a crushing mechanism.

The base portion of each of the inserts may have threads. The wear body may also have threads formed adjacent to each of the channels to mate with the threads of the inserts. The inserts may be positioned in the wear body via rotation of each of the inserts within a respective one of the channels such that the base portion of each insert mates with the threads adjacent to the channel in which that insert is being positioned.

Some embodiments of the method may include positioning retaining members so that each retaining member is positioned adjacent to a respective one of the inserts. The retaining members may be positioned to engage with a portion of the mounting body or a portion of the wear body when the mounting body is attached to the wear body. In some embodiments, the retaining members may be the fasteners such that all the fasteners are retaining members. Such retaining members may be configured to have a head that is sized to receive a base portion of an insert. A respective retaining member may be positioned to engage the base portion of a respective one of the inserts for attaching the inserts to the mounting body. Such a use of retaining members may be particularly preferred when the mounting body and wear body are portions of an integrally formed or cast crushing body.

The wear body may be formed in any of a number of ways. For instance, the wear body may be one integrally formed structure, such as a molded structure. As another example, the wear body may be formed with the mounting body such that both the mounting body and the wear body are portions of an integrally formed structure or an integrally cast structure. As yet another example, the wear body may be formed by connecting at least one outer portion to at least one inner portion. The inner and outer portions may define the crushing surface of the wear body. The one or more inner portions may be composed of a material that is harder or softer than the material of the one or more outer portions so that the crushing surface experiences wear differently at different locations. For instance, the inner and outer portions may be composed of metal or a composite material that have different hardnesses. Preferably, the outer portions include at least one side that has a profile configured to mate or interconnect with the profile of a side of an inner portion. The mating profiles may help strengthen the connection between the inner and outer portions.

The mounting body may also be formed in a number of ways. For instance, the mounting body may be cast or molded as a unitary structure, may be cast or molded as a portion of the crushing body that is adjacent to the wear body, or may be formed by interconnecting multiple portions together. The multiple portions may be welded, fastened, hot pressed, or bonded together or may be individually connected to the wear body via welding, hot pressing, bonding, or fastening mechanisms. Of course, a combination of such connection mechanisms may also be utilized to interconnect the multiple portions.

A crushing body is also provided. The crushing body may include a wear body that has channels, inserts that are at least partially positioned in the channels, and a mounting body that has at least one of recesses and bosses. The mounting body is attached to the wear body such that the base portions of each of the inserts are positioned adjacent to the mounting body. A plurality of fasteners is also included. Each of the fasteners may extend through the mounting body and into at least one of a respective one of the inserts and the wear body.

It should be appreciated that embodiments of the crushing body may include sleeves for inserts, a fastening member, or threaded inserts and threads formed on the wear body, or other features of crushing bodies discussed above with reference to embodiments of the method (which are also discussed more fully below).

Other embodiments of the crushing body for a crushing device may include a wear body, a fastening member attached to the wear body, a mounting body, and fasteners that extend from the mounting body to the fastening member to connect the fastening member to the mounting body. In some embodiments of the crushing body, the fasteners may also extend into the wear body. The fastening member may be integral with the wear body or may be a separate member that is attached to the wear body. The fastening member may be, for example, cast, hot pressed, molded, bonded, or fastened to the wear body. For example, the fastening member may be attached into or on a surface of the wear body that is opposite the crushing surface of the wear body. It should be understood that the fastening member may be adhered, glued, bonded, or hot pressed to the mounting body in addition to the insertion of the fasteners for some embodiments of the crushing body.

For some embodiments of the crushing body, the fastening member may include one or more projections that define insert members that extend into channels formed in the wear body. The insert members may be comprised of metal, ceramic material, non-metal material, or a composite material that is harder or softer than the metal or composite material of the wear body. Preferably, the insert members define a portion of a crushing surface of the wear body.

A crushing device is also provided. The crushing device may include a frame and at least one crushing body connected to the frame. For instance, an axle or an actuation mechanism may connect a crushing body to the frame. Each of the crushing bodies may be an embodiment of an above discussed crushing body that is also discussed more fully below. For instance, each of the one or more crushing bodies may include a wear body that has channels, inserts positioned in the channels, a mounting body attached to the wear body so that a base portion of each of the inserts is positioned adjacent to the mounting body, and a plurality of fasteners that each extend through the mounting body and into at least one of a respective one of the inserts and the wear body. Embodiments of the crushing device may include mills, roller mills, crushers, cone crushers, roller presses, jaw crushers, presses that comminute material, or a grinding device.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred embodiments of crushing bodies are shown in the accompanying drawings. It should be understood that like reference numbers used in the drawings may identify like components.

FIG. 1 is an exploded view of a first present preferred embodiment of the crushing body 1.

FIG. 2 is a bottom perspective view of a wear body portion 3 of the first present preferred embodiment of the crushing body 1.

FIG. 3 is a fragmentary cross sectional view of a portion of the first present preferred embodiment of the crushing body 1 that illustrates an insert 7 positioned within a portion of the wear body 3.

FIG. 4 is a perspective view of the first present preferred embodiment of the crushing body 1 with a portion of the crushing body cut away to illustrate inserts 7 and fasteners 9 positioned therein.

FIG. 4A is a cross sectional end view of the first present preferred embodiment of the crushing body 1.

FIG. 4B is a perspective view of one preferred embodiment of the crushing body 1 with a portion of the crushing body cut away to illustrate an alternative arrangement of inserts 7 and fasteners 9 positioned therein.

FIG. 4C is an enlarged cross sectional view of a present preferred embodiment of an insert 7 positioned within a portion of a crushing body 1 adjacent to a retainer 27.

FIG. 4D is a view similar to FIG. 4C illustrating the retainer 27 positioned to help retain an insert 7 within the crushing body 1.

FIG. 5 is a cross sectional view of a third present preferred embodiment of the crushing body 51.

FIG. 6 is a cross sectional view of yet another alternative insert 57b and sleeve 58b arrangement that may be utilized in embodiments of the crushing body 51b.

FIG. 7 is a perspective view of another preferred embodiment of a crushing body 61.

FIG. 8 is a top perspective view of yet another preferred embodiment of a crushing body 111.

FIG. 9 is a cross sectional view of yet even another preferred embodiment of a crushing body 111 taken along line IX-IX in FIG. 8.

FIG. 10A is a perspective view of an embodiment of an insert 137a that may be utilized in embodiments of a crushing body.

FIG. 10B is a perspective view of another embodiment of an insert 137b that may be utilized in embodiments of a crushing body.

FIG. 10C is a perspective view of yet another embodiment of an insert 137c that may be utilized in embodiments of a crushing body.

FIG. 10D is a perspective view of an additional embodiment of an insert 137d that may be utilized in embodiments of a crushing body.

FIG. 10E is a perspective view of yet another embodiment of an insert 137e that may be utilized in embodiments of a crushing body.

FIG. 10F is a perspective view of yet another additional embodiment of an insert 137f that may be utilized in embodiments of a crushing body.

FIG. 10G is a perspective view of yet another additional embodiment of an insert 137g that may be utilized in embodiments of a crushing body.

### DETAILED DESCRIPTION OF PRESENT PREFERRED EMBODIMENTS

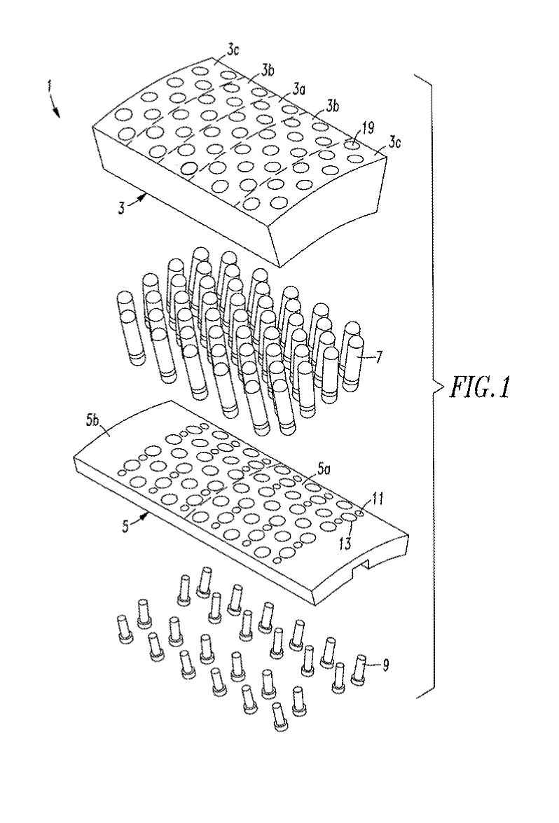

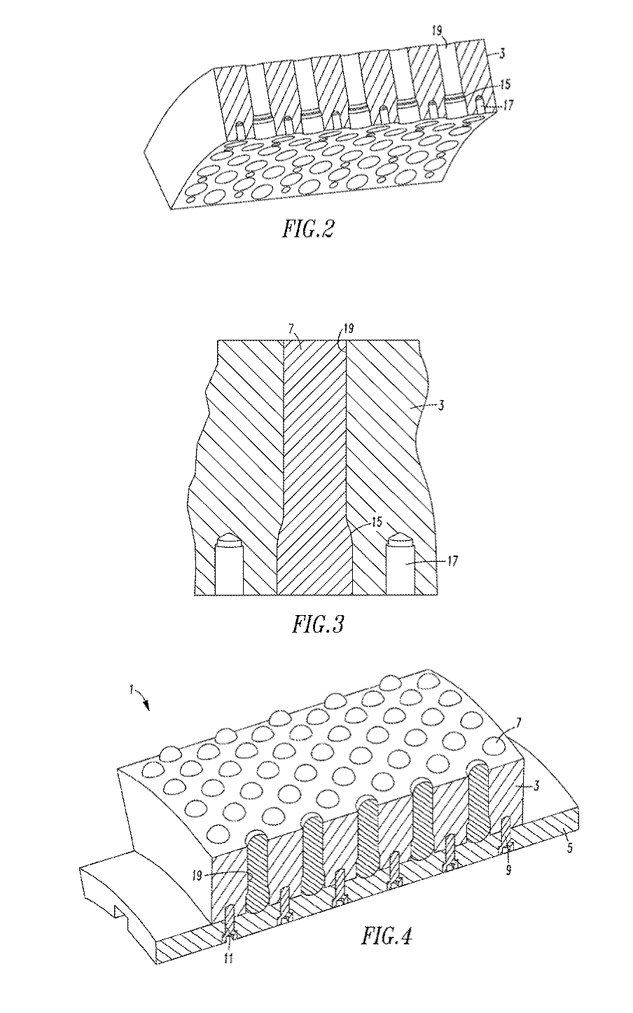

Referring to FIG. 1, a crushing body 1 may include a wear body 3 that is attached to a mounting body 5. Inserts 7 may be positioned between the wear body 3 and the mounting body 5. A portion of each insert 7 may be positioned in a respective channel 19 of a plurality of channels 19 formed in the wear body 3. Each insert 7 may have a base portion 8 that fits within a recess 13 or aperture formed in the mounting body 5. Alternatively, the base portion 8 of each insert 7 may be supported by a boss or raised portion of the mounting body 5 (not shown).

Fasteners 9 may extend through holes 11 or other apertures in the mounting body 5 and into apertures or grooves 17 formed in the wear body 3, such as threaded openings formed in inserts positioned in the wear body 3, to mechanically attach the mounting body 5 to the wear body 3. Of course, the mounting body 5 may also be attached via an adhesive, welding or bonding agent in addition to the mechanical connection provided by the fasteners 9 to strengthen the attachment between the mounting body 5 and the wear body 3.

The channels 19 in the wear body may include stop portions 15 of a larger diameter or stop portions that taper from a wider width to a narrower width to receive base portions 8 of respective inserts 7. The stop portions 15 may be adjacent to the channels 19 and define a portion of the channels 19. The insert 7 may be tapered such that the base portion 8 of each insert 7 is wider than other portions of the insert 7 that extend above or below the base portion 8 and into the wear body 3. The reduction in width of the channels 19 permit the stop portions 15 of the wear body 3 to provide a mechanical interlock with the base portions 8 of the inserts 7 to help lock the inserts at a desired position in the wear body 3 of the crushing body 1. Each stop portion 15 may be a portion of the wear body 3 that defines a small section or subpart of the entire channel 19. In other embodiments, each stop portion may be substantially the entire part of the wear body 3 that is adjacent to the channel 19 and defines the channel.

The inserts 7 may be positioned in the wear body 3 by pushing or pressing the inserts 7 through the channels 19 from a side of the wear body, such as the bottom of the wear body 3, a top of the wear body, or a side of the wear body that is opposite the crushing surface of the wear body. The mounting body 5 may then be positioned over that side of the wear body 3 to sandwich the inserts 7 between the wear body 3 and the mounting body 5 or to provide a mounting profile for mounting the wear body to a component of a crushing device.

Fasteners 9 may then be positioned to connect the mounting body 5 to the wear body 3. The fasteners 9 may be, for example, screws, bolts, rivets, threaded fasteners or other types of fasteners or fastening mechanisms. Alternatively, or in addition, at least some of the fasteners 9 may be positioned in the mounting body 5 to connect with corresponding threads in the inserts 7 to directly attach the mounting body 5 to the inserts 7.

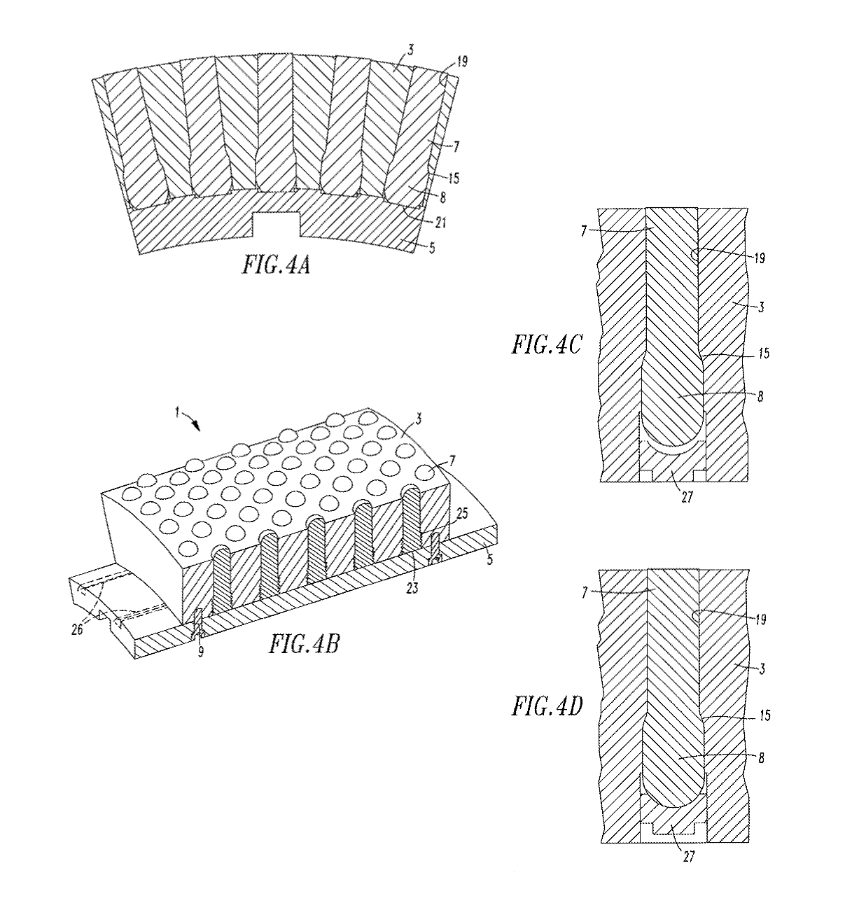

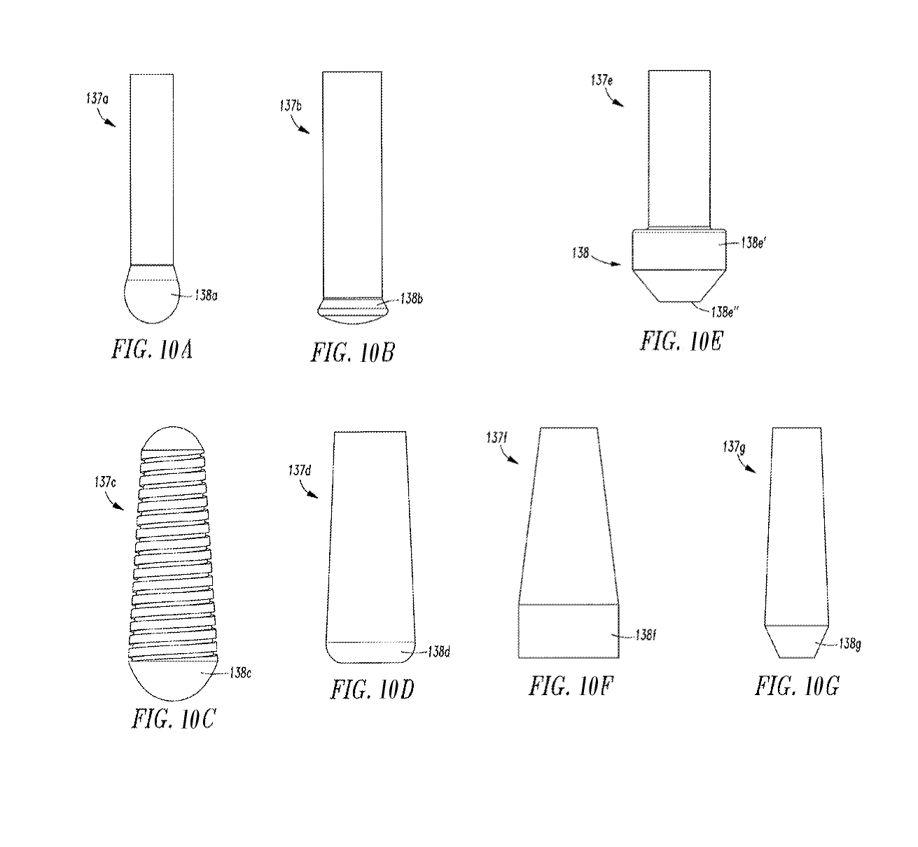

As may be appreciated from FIGS. 4 and 4A, and FIGS. 10A-10G (discussed more fully below), base portions 8 of the inserts may have a number of different geometric shapes. For instance, the bottom portion of each insert 7 may be rounded and the recesses 13 in the mounting body 5 may have a complimentary curved shape to receive the rounded bottom portions of the inserts 7. As another example, the bottom 21 of each base portion 8 may be flat or substantially flat and be received on a flat or substantially flat recess 13 formed on the mounting body 5. In yet other embodiments, the inserts 7 may have a consistent width or diameter and have a rounded, flattened, angled, or tapered base portion or may have other configurations as may be appreciated from FIGS. 10E-10F.

Of course, the base portion 8 of each insert 7 may have other configurations. For instance, a larger diameter base portion of each insert may be threaded such that each insert has a base portion 23 that has threads 25 formed thereon. The threads 25 may mate with threads defined in the bottom portion of the channels 19 formed in the wear body 3 to permit the inserts to be screwed into the wear body and possibly engage stop portions 15 or lock against stop portions 15 defined within channels 19. The stop portions 15 may be, for example, stop features or stop profiles defined by the shape of a portion of the channels 19. The mounting body 5 may also have apertures that align with the channels 19 and may have threads formed in these apertures to mate with the threads 25 of the base portion 23 as well, such that the threads 25 of the inserts 7 may be rotated within the apertures to move of the mounting body 5 toward the channels of the wear body 3.

As yet another example, the inserts 7 may be positioned in the channels 19 and then a retainer such as a retaining member 27 may be positioned in the channels 19 under the base portion 8 of each insert 7 to interlock with the base portion 8 of the insert 7 to help affix the insert 7 to the wear body 3. The retaining members 27 may be particularly useful for embodiments of the crushing body 1 that have the wear body 3 and mounting body 5 formed as integral portions of the crushing body 1.

The retainer members 27 may be threaded so that they are moveable along the channels 19 or apertures formed in the mounting body 5 to interlock with or engage a base portion 8 of a respective insert 7 within each channel or aperture 19. A bottom portion or middle portion of each retainer member 27 may be shaped to engage with a portion of the mounting body 5 or one or more intermediate members positioned between the retainer members 27 and the mounting body 5. Alternatively, there may be a space or gap between the retainer members 27 and the mounting body 5. In yet other embodiments, the retainer member 27 may have a bottom or middle portion configured to engage with a portion of the wear body 3.

As another alternative, the retaining members 27 may be fasteners 9 that retain the inserts 7 to the wear body 3 and/or the mounting body 5. For instance, fasteners 9 may be retainer members 27 that are inserted through the mounting body 5 to engage with the inserts 7 to attach the inserts 7 and wear body 3 to the mounting body 5. A head of each retaining member 27 may have an opening for receiving a base portion of a respective one of the inserts. As another example, the retaining members 27 may be positioned in the channels 19 and subsequently crimped or welded to position the retaining members 27 and engage the inserts 7 to help retain the inserts within the wear body 3.

It should be understood that portions of the mounting body 5 may also include a mechanical interlocking feature 26 as shown, for example, in dotted line in FIG. 4B. For instance, the mounting body 5 may include a groove or channel such as dovetail groove for receiving a boss or projection of the wear body 3 such as a dovetail to provide a mechanical interlock between the two bodies. Other interlock features may be provided in addition to such grooves or channels or as an alternative to such an arrangement. For example, the interlocking features 26 for the wear body 3 and the mounting body 5 may include dowel pins formed in one body that fit within openings formed in the other body, or a keys and keyways arrangement so that keys formed in one body fit within keyways formed in the other body.

The crushing body 1 may be a roller, a die, a table, a portion of a die, or a portion of the surface of a table on which material is crushed. Alternatively, the crushing body 1 may be a segment of a roller that is to be interconnected with other segments to form a roller body for a roller of a roller mill or roller press. The wear body 3 may have a surface that is configured to form an autogenous or semi-autogenous layer for crushing material.

While crushing body 1 shows arcuate mounting and wear surfaces, it should be understood that flat mounting surfaces may be alternatively employed. For instance, the wear or mounting surfaces may be planar, polygonal shaped, or have other shapes, sizes, or configurations for use in a particular type of crushing device or to meet a particular design objective.

Preferably, the inserts 7 are harder than the material of the wear body 3 and mounting body 5. It is contemplated, however, that the inserts may be softer than the material of the wear body 3 to define recesses on the surface of the wear body 3 when the crushing body is in operation to form pockets for receiving material that is being crushed or comminuted by the crushing body to help form an autogenous or semi-autogenous layer for the comminution of material.

As may be appreciated from FIG. 1, some contemplated embodiments of the crushing body 1 may include a mounting body 5 that is formed by two or more different parts that are interconnected via welding, hot isostatic pressing, fasteners, bonding, adhesives, mechanical interlocking features, interference fits, fastening mechanisms or a combination thereof. For example, a first mounting body part 5a may be interconnected to a second mounting body part 5b by fasteners (not shown) and/or also by welding, bonding, or hot pressing the two parts 5a and 5b together to form the mounting body 5.

It is also contemplated that the wear body 3 may be formed of multiple parts 3a, 3b, and 3c, which are shown in dotted line in FIG. 1. The different parts may be interconnected via welding, fasteners, bonding, hot isostatic pressing fastening mechanisms or a combination thereof. The parts may also be shaped to interlock with each other. For instance, parts 3c may have a side profile that interlocks with a side profile of parts 3b, and parts 3b may have side profiles that interlock with the sides of part 3a and 3c. It should be understood that an outer side of each of parts 3c that is opposite the side connected to part 3b could be configured to interlock with an edge protection mechanism.

Moreover, the composition of each part of the wear body 3 may be different to provide a more desirable wear profile or crushing layer profile. For instance, parts 3c may be composed of metal or other material that is softer than parts 3b and 3a, and part 3a may be composed of metal or other material that is harder than part 3b. As another example, parts 3c may be composed of metal or other material that is harder than parts 3a and 3b. In some embodiments, parts 3a and 3b may be composed of the same material or a material of different hardnesses or toughnesses.

Of course, embodiments of the crushing body may be formed in other ways or have other structures. For example, as shown in FIG. 4, a crushing body 1 may be formed so that the inserts 7 substantially project from the channels 19 formed in the crushing body 1.

Moreover, in some embodiments, portions of the crushing body 1 may be formed by multiple layers of similar or dissimilar materials which are bonded together to define a hard wear surface of the crushing body. For instance, the layers may be welded or bonded via hot isostatic pressing. The layers may each be of different hardness and one or more of the layers may be harder or softer than the inserts 7. The outermost portion of each insert 7 may be recessed relative to the outer surface of the wear body 3, flush relative to the outer surface of the wear body 3, or may extend outwardly from the wear body 3. In some embodiments, a first portion may be an intermediate wear body substrate, a second portion may be a wear surface portion, and a third portion may be a mounting body portion.

In some contemplated alternative embodiments, the inserts 7 may be softer than the wear body 3 or be partially or fully surrounded by sleeves. It should be understood that the spacing of the inserts 7 and the hardness of the inserts 7 and outer surface of the wear body 3 may be configured to define a desirable wear surface that is sized and shaped for meeting a desired material comminution design objective such as, for example, establishing an autogenous layer for the crushing surface of the crushing body 1.

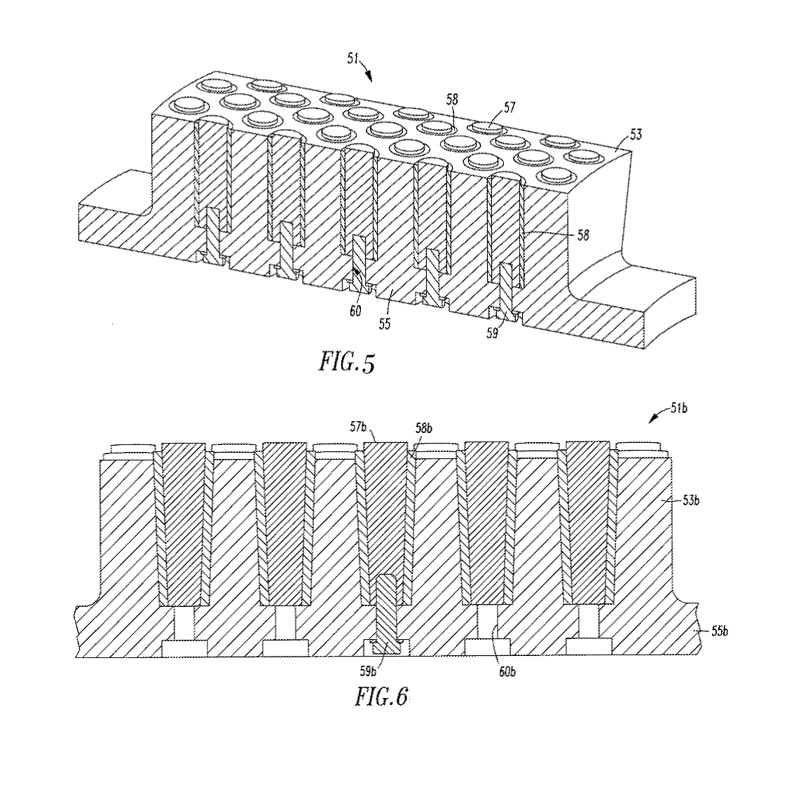

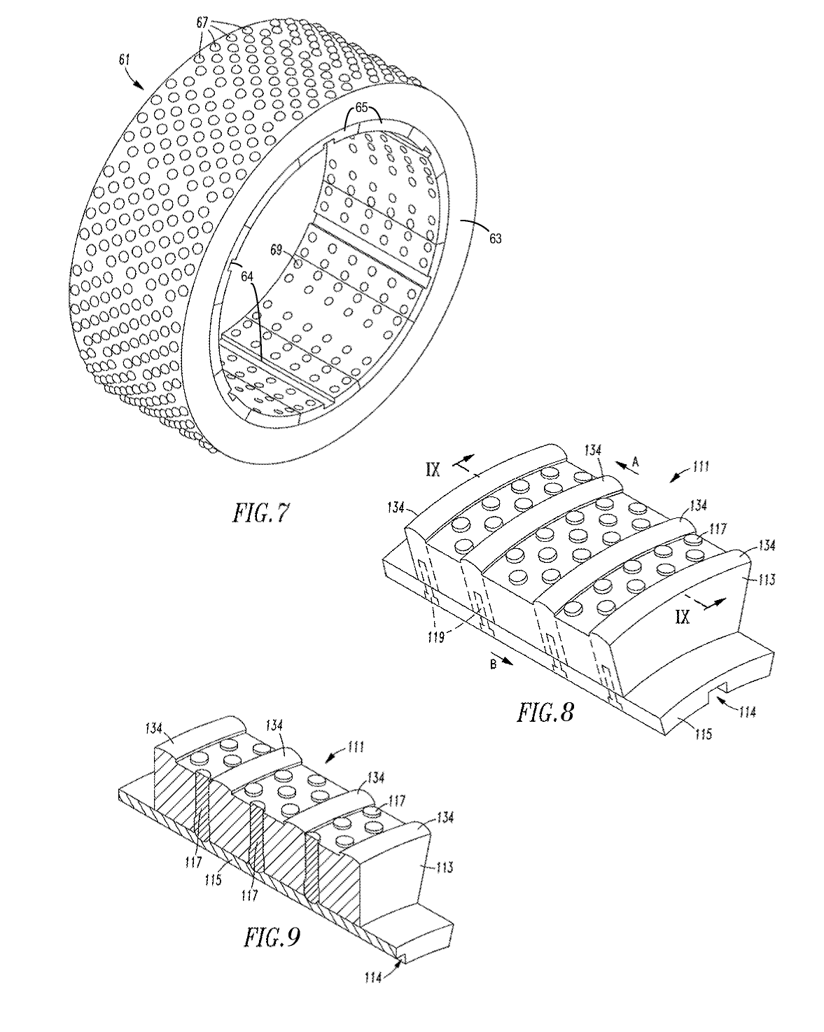

Referring to FIG. 5, a crushing body 51, 51b can also be formed by using sleeves 58, 58b to help protect the inserts 57, 57b and connect inserts to one or more portions of the crushing body. For instance, a crushing body 51 includes an outer portion 53 and an inner portion 55. The outer portion 53 may have channels sized to receive inserts 57 and sleeves 58. Each sleeve 58 may be positioned to encircle at least a portion of the surface areas of a respective insert 57. Each insert may be positioned within a respective sleeve. Then, the insert 57 and sleeve 58 in which that insert is positioned may be positioned within a respective channel of the outer portion 53. The sleeve 58 may be bonded or adhered to the outer portion 53 within the channel.

For example, each sleeve 58 may be shrink fitted or glued in place within a respective one of the channels. Each insert 57 may then be pushed, pulled, or pressed into the sleeve 58. Alternatively, a fastener 59 may be inserted into the insert to push, pull, press or otherwise position the insert 57 within the sleeve 58. The inner diameter of the channel formed in each sleeve 58 may be covered in glue or other adhesive to help position, secure, and attach the insert 57 within the sleeve 58.

Alternatively, or in addition, an application of force may be provided to attach the sleeves 58 and inserts 57 to the outer portion 53. For instance, an explosive material may be detonated to explosively forge the inserts and sleeves to the outer portion 53. Fasteners 59 may then be positioned within apertures 60 formed in the inner portion 55 and connected to the inserts 57. Each fastener 59 may be connected to a respective insert 57. The inserts 57 may have an aperture sized and configured to receive an end portion of a respective one of the fasteners 59.

In a contemplated alternative embodiment, the sleeves 58 may have threads that mate with threads (not shown) defined in the channels of the outer portion 53 to permit the sleeves 58 to be rotated and threadably connected to the outer portion 53. For such an embodiment, the inserts 57 may first be positioned within and attached to the sleeves 58. Thereafter, threaded the sleeves 58 may be positioned within the channels to position the sleeves and inserts in the outer portion 53 of the crushing body 51.

Each aperture 60 may include a wide portion for receiving a head or wide portion of a fastener 59 and a narrower channel sized to receive a middle portion and an end portion of the fastener to permit the fastener 59 to connect with an insert 57. The wide portion of the aperture 60 may permit the head of the fastener 59 to directly engage a portion of the inner portion 53 to ensure tight connections between the inserts and the inner portion 55 via the fasteners 59.

It should be appreciated that the inner portion 55 and outer portion 53 of the crushing body may be portions of an integrally formed or cast body or may be separate pieces that are interconnected via welding, bonding, the use of fasteners or a combination thereof. The inner portion 55 may be a mounting body and the outer portion 53 may be a wear body. The inserts 57 may be harder than the material of the sleeves 58 and the sleeves 58 may be harder than the material of the outer portion 53. Of course, the inserts 57 may also be softer than the sleeves 58, but harder than the outer portion 53. The sleeves 57 may be softer than the outer portion 53, but harder than the inserts 57 or the outer portion 53 may be harder than the inserts 57 but softer than the sleeves 28. In yet other embodiments, the outer portion 53 and the inserts 57 may be the same material or be composed of material that has the same or substantially the same hardness. In other embodiments, the sleeves 58 may be harder than the inserts 57 and outer portion 53 or may be softer than the outer portion 53 and the inserts 57. The sleeves 58 may be composed of a non-metal, a composite material, or a metal such as steel or an alloy.

When the sleeves 58 and inserts 57 are positioned in the channels of the outer portion 53, a portion of each sleeve 58 and a portion of each insert 57 may extend from the outer surface of the outer portion 53, as may be appreciated from FIG. 6. The outermost portion of each insert 57 may extend farther from the outermost portion of each sleeve 58. In alternative embodiments, the outermost portion of the insert 57 may be recessed relative to the outermost portion of the sleeve 58 that encircles a portion of that insert 57. In yet other embodiments, the outermost portions of the inserts 57 and sleeves 58 may extend the same distance.

In other embodiments, the outer ends of the inserts 57 may be recessed relative to the crushing surface or outer surface of the outer portion 53 and the sleeves 58. In yet other embodiments, the sleeves 58, the inserts 57, or both the inserts and sleeves may be flush with the outer surface of the outer portion 53. When the sleeves 58 or the inserts 57 are recessed relative to the outer portion's outer surface, the sleeves may be flush with the inserts, or may be positioned further outward or less outward than an end of the insert 57 relative to the surface of the outer portion 53.

The sleeves 58, inserts 57 and channels formed in the outer portion 53 to receive the sleeves and inserts may be straight or may have other configurations. For instance, as may be appreciated from FIG. 6, the inserts 57b and sleeves 58b may be tapered to fit within a tapered channel. Each insert 57b may be engaged with or attached to a fastener 59b that extends from an inner portion 55b.

While not shown, the inserts 57 and sleeves 58 may be tapered such that the outermost portion of each insert is narrower than the inner most portion of each insert 57 and sleeve 58, in which the fasteners 59 may be retaining members 27 as shown in FIGS. 4C and 4D. Alternatively, the inserts 57b and sleeves 58b may be tapered such that the innermost portion of each insert and sleeve is narrower than the outermost portion of each insert 58b and sleeve 58b, as may be understood from FIG. 6. Fasteners 59b may be retaining members that are positioned in the inner portion 55b of the crushing body 51b to connect with or engage a base portion of each insert 57b. The base portion of each insert 57, 57b may comprise a material which is softer than an outer crushing portion of the insert. For example, an insert 57, 57b may be formed with a hardness gradient or selective hardening, such that substantially the entire insert 57, 57b is harder than a base portion. The gradient hardness may be achieved using a layered or selective cooling powder metal sintering process, for example, as described in United States Patent Application Publication No. 2010/0319650 and U.S. Pat. No. 6,787,100. The base portion may be machined for engagement with a fastener 59, 59b or otherwise deformed into a channel 19 of a wear body 3, adjacent stop portions 15. Alternatively, a threaded insert may be soldered within a complimentary pocket formed within a base portion of an insert having uniform hardness.

It should be appreciated that the inserts 57 or 57b may be press fit into the sleeves 58 or 58b prior to positioning within the outer portion 53, 53b. For example, the inserts 57b may be positioned in the sleeves 58b and thereafter the sleeves may be positioned in the outer portion 53b to position the sleeves and the inserts in the outer portion 53b. As another example, the sleeves 58b may be positioned in the outer portion 53b and thereafter the inserts 57b may be positioned into the sleeves 58b. A fastener 59b for example, may be used to draw a respective one of the inserts 57b into a respective one of the sleeves 58b to position the inserts 57b into the outer portion 53b.

Embodiments of the crushing body may include segments that are configured to be interconnected to form a sleeve or roller. Other embodiments of the crushing body may be sized and configured to form a roller, sleeve, die, anvil, or other crushing body. For instance, a crushing body 61 may be made such that a wear body 63 has inserts 67 positioned therein and attached thereto. The inserts 67 may include an outer portion that projects from the outer surface of the wear body 63. In alternative embodiments, the inserts 67 may be flush with the wear body 63 or may be recessed relative to the wear portion of the wear body 63. The crushing body 61 may be formed as a sleeve as shown.

The crushing body 61 may also include a plurality of mounting bodies 65 connected to the wearable bodies 63. The mounting bodies 65 may be, for example, segments. The mounting bodies 65 may include one or more profiles 64 such as grooves, apertures, or other shaped openings or shaped portions that are sized and configured to provide a mating connection with a portion of a roller, shaft, support, other type of member, or other component of a crushing device. In alternative embodiments, the profiles 64 may include projections that are sized and configured to fit within recesses formed on the shaft, roller or other member or component of a crushing device. The projections may define a mating shape for interconnecting with a shaft or roller, support, other type of member of a crushing device or another component of a crushing device.

Fasteners 69 may extend through holes in the mounting bodies 65 to connect the mounting bodies 65 to the wear body 63. When a wear body 63 needs replacing, the fasteners 69 may be removed to disconnect the wear body 63. A new wear body 63 may replace the removed one. Fasteners 69 may be used to connect the new wear body 63 to the mounting bodies 65.

While not shown, a crushing body 61 may be formed such that the inserts 67 are molded or cast in wear body 63. The inserts 67 may be shaped to include a profile that provides a desired design or configuration so that the wear body 63 and inserts 67 define an autogenous layer or a semi-autogenous layer as the inserts 67 are exposed. The mounting bodies 65 may be an integral portion of the crushing body 61 or may be a separate member or body. The mounting bodies 65 may be members of any of a number of types of geometrical configurations such as a polygonally shaped plate or a circular shaped plate, a flat plate, an elliptical shaped plate, an annular shaped plate, or an arc-shaped plate.

The fasteners 69 may extend to the inserts 67 (as shown in FIG. 6), may extend to the wear body 63 (as shown in FIG. 4), or may be positioned so that some fasteners 69 extend to the wear body 63 and others extend to the inserts 67. The mounting body 65 may also include a profile 64 to provide an attachment to a support or other member of a crushing device. The profile 64 may be, for instance, one or more grooves formed in a bottom portion of the mounting body 65 or may include one or more protrusions, beads, or projections that extend from the mounting body 65 to engage or mate within a recess or aperture of a support, member, roller, shaft or other component of a crushing device.

In yet other embodiments of the crushing body, the crushing body may or may not include any inserts. For instance, a crushing body 1 may be cast to have a wear body portion 3 that is connected to a mounting body portion 5 via an intermediate fastening member. For example, in some embodiments, the fastening member may comprise an embedded or otherwise attached plate provided to the wear body 3. The fastening member may be a plate that has any of a number of shapes or configurations. For example, the fastening member may include a plurality of upper projections and upper recesses for interlocking with recesses and projections defined on a side of the wear body 3 to help the fastening member be attached or stay attached to the wear body 3. The fastening member may be attached to the wear body 3 via any of a number of options such as welding, bonding, adhering or affixing the fastening member to the wear body 3. The opposite side of the fastening member may also include projections and recesses for interlocking with a profile defined on a side of the mounting body 5.

Fasteners 9 may extend through apertures formed in a mounting body 5 to connect the mounting body 5 to the fastening member and wear body 3. It is contemplated that fasteners 9 could also extend through the fastening member and into a portion of the wear body 3. Alternatively, a separate set of fasteners 9 could extend from the fastening member to the wear body 3 to help connect the wear body 3 to the fastening member.

According to some methods of making crushing bodies 1, one or more projections that define insert members may be provided to a crushing device to comminute material.

In some alternative embodiments, the fastening member may be integral with the wear body 3. For instance, the fastening member may be cast as a portion of the wear body 3 or may be welded, bonded, adhered or affixed to the wear body 3. In yet other embodiments, the fastening member may be integral with the mounting body 5 or may be welded, bonded, adhered, or otherwise affixed to the mounting body 5.

It is contemplated that the wear body 3 may have rectangular or otherwise box-shaped inserts 7 positioned therein. For instance, one or more rectangular or otherwise box-shaped inserts 7 may be positioned in channels or bores 19 that are formed or drilled into the wear body 3.

It is also contemplated that the fastening member could have inserts 7 attached thereto or formed thereon. The inserts 7 may be positioned in channels 19 formed in the wear body 3 and portions of the fastening member. The fastening member could be welded, fastened, or otherwise attached to the wear body 3. For instance, inserts could be placed or pressed in the wear body channels and then welded or fastened to the fastening member at a side opposite the crushing surface of the wear body 3.

In alternative embodiments, projections of the fastening member, for instance, a series of upstanding parallel fins, may be shaped to contain insert-like features or to act as inserts. Such projections could be considered to be insert members. For such embodiments, the fastening member may be cast into the wear body 3. The wear body 3 may include an outer surface that is composed of metal, non-metal or a composite material and surrounds or at least partially surrounds the projections of the fastening member. The mounting body 5 may be attached to the fastening member via fasteners 9. The fasteners 9 may extend into the projections of the fastening member or may be staggered so that the fasteners 9 do not extend into the projections. The mounting body 5 may also include one or more grooves, apertures, protrusions or projections that define a profile for aiding connection to a component of a crushing device.

The projections may be formed from a metal or non-metal material that is harder than the metal or non-metal material of the outer surface of the wear body 3. Alternatively, the projections may be composed of a metal, non-metal material, or a composite material that is softer than the material of the outer surface of the wear body 3. The projections may help provide material draw in, help control axial material movement, and help define an autogenous layer for the crushing surface of the crushing body 1.

Other embodiments of the crushing body may include wear bodies that are fastened to a plurality of interconnected mounting bodies which are interconnected on their sides by one or more castellated or dovetail features. The wear bodies may be, for example, grinding members or crushing members. The wear bodies may partially define a crushing surface of the crushing body. Each wear body may be attached to a portion of an interconnected mounting body 105 via one or more fasteners that extend through the mounting body and into the wear body. The wear bodies may include inserts, sleeves, and/or pockets of harder or softer material that are positioned therein, or may not include such inserts or pockets of material. The wear bodies may also include threaded openings formed therein to receive fasteners.

While not shown, some embodiments of a crushing body 51 may include a plurality of supplemental grinding members attached to an outer portion 53 already having inserts 57 and sleeves 58 positioned therein. The grinding members may be attached to the crushing body 51 by fasteners 59 and/or via welding, bonding or gluing the grinding members to the outer portion 53 of the crushing body 51. The grinding members may be composed of a hard metal or may be composed of a hard composite material. It should be understood that grinding members, inserts 57 and sleeves 58 may be subsequently connected to the crushing body 51 in any order of preference.

In some embodiments, a crushing body 51 may include a grinding member that is one relatively large monolithic structure positioned between a series of inserts 57 with sleeves 58. In such embodiments, the crushing body 51 may include portions that define a relatively large complimentary opening for receiving the relatively large grinding member. The sides of the grinding member may include profiles for interlocking with mating profiles formed in portions of the crushing body 51 which are configured to receive the grinding member and which define said complimentary opening. Sleeves 58 and inserts 57 may be attached to only peripheral portions of the crushing body 51 on opposite sides of the grinding member adjacent the edges of the crushing body 51 which define a perimeter of the crushing surface. The inserts 57 may be affixed to the peripheral portions of the crushing body 51 via a fastener 59 and/or the use of other fastening mechanisms.

The wear body portion of a crushing body 111 may also be formed to include one or more material dams to help prevent substantive axial sliding of material when the material is being crushed. For instance, a crushing body 111 may include a wear body 113 attached to a mounting body 115 having a profile 114. The wear body 113 may include a plurality of inserts 117 positioned therein and may include a plurality of material dams 134 formed on the crushing surface of the wear body 113 or attached to the crushing surface of the wear body 113. The material dams 134 may be integrally connected to the wear body 113.

As an alternative, the material dams may be attached to the mounting body 115 via one or more fasteners 119 as shown in dotted line in FIG. 8 such that the material dams 134 may be replaced by removing the fasteners 119 to remove a damaged or worn material dam 134 with a new material dam 134 that may then be attached via insertion of the fasteners 119. For such embodiments, the fasteners 119 may be inserted into the mounting body 115 and extended into the material dams 134 so that the fasteners 119 are positioned in a side portion of the material dams 134 that is opposite the crushing surface of the crushing body 111.

In some embodiments, material dams 134 may be formed as shallow members which do not extend deep enough to abut the mounting body 115, but are instead seated in a shallow blind channel or recess in the wear body 113. Fastening mechanisms such as, for example glue, press-fit interferences, bonding, or welding, may also be utilized to help affix a new replacement material dam 134.

The material dams 134 may help entrain material positioned between adjacent material dams to prevent substantial material sliding in the axial directions A and B. The axial directions A and B may be defined by an axle or roller or shaft that the crushing body 111 rotates about. The axial direction may also be defined as a direction that is transverse, substantially perpendicular or perpendicular to a direction upon which force is applied by the crushing body 111 for crushing material.

It should be understood that “inserts” where described herein, may have any of a number of possible shapes or configurations. For instance, in addition to the above mentioned and above referenced inserts, inserts may be shaped similarly to the inserts 137a, 137b, 137c, 137d, 137e, 137f, or 137g shown in FIGS. 10A-10G or may be configured to have base portions 138a, 138b, 138c, 138d, 138e, 138f, or 138g that has any of a number of different shapes or configurations as shown in FIGS. 10A through 10G.

For instance, base portions of the inserts may be rounded or may define a half hemisphere, a full hemisphere, or a substantial portion of a hemisphere as shown in FIGS. 22A through 10C. Alternatively, inserts may be tapered and have a wider base portion that has a substantially flat bottom surface as shown in FIG. 10D. As yet another example, inserts may be threaded or have grooves formed thereon as shown in FIG. 10C. The grooves may provide a place for material to be located when a crushing body is comminuting material to help form an autogenous layer to better crush the material. As yet another example, inserts may be configured to provide a base portion that is narrower or wider than the portion of the insert 137a-137g above or below the base portion 138a-138g. For instance, the base portion 138e of the insert 137e shown in FIG. 10E may be configured to permit a first portion 138e′ of the base portion to engage a stop defined in a wear body by the geometry of the channel, and a second portion 138e″ opposite the first portion 138e′ to engage a portion of a mounting body such as a boss or a portion of the mounting body that defines a recess that receives the base portion 138e. As yet other examples, inserts may have base portions 138f and 138g that are sized and shaped as shown in FIGS. 10F and 10G.

As may be understood by those of at least ordinary skill in the art, embodiments of the crushing bodies discussed herein may be included in any of a number of different crushing devices. For example, embodiments of the crushing body may be utilized in any of a number of different types of crushing devices such as, for example, roller mills, roller presses, other types of mills, cone crushers, jaw crashers, gyratory crushers, and other types of crushing devices. The crushing bodies may be used to comminute material such as ore, rock, stone, agglomerated material, material used to make cement, minerals, metals, or other material.

For example, a crushing body may be connected to or form portions of a a liner or mantle or otherwise be attached to a liner or mantle of a cone crusher or gyratory crusher. The head of the cone or gyratory crusher may also comprise a crushing body that is shaped to define the head of the cone or gyratory crusher.

As another example, one or more crushing bodies may be attached to rollers that rotate and crush material between the crushing bodies and a table in a roller mill. The table of the roller mill may also include one or more crushing bodies that define a wear surface or crushing surface of the table. The crushing bodies of the table may be supported by a support or may be an integral portion of the table.

As yet another example, crushing bodies may be shaped to form a crushing surface or entire portion of a die of a mill that is actuated by actuators to move the die to crush material positioned on a table or anvil. The anvil may also comprise one or more crushing bodies to define a crushing surface of the anvil.

As yet even another example, crushing bodies may be shaped to form a crushing surface or entire portion of a jaw or other crushing surface of a jaw crusher that is actuated by a rotary drive with linkages.

Methods of making crushing bodies may also be appreciated. The methods may include attaching inserts to a wear body and utilizing fasteners to connect the wear body to a mounting body. Preferably, the fasteners are positioned to extend through the mounting body and into a base portion of the wear body, base portions of the inserts, and/or both base portions of the wear body and base portions of the inserts. The inserts may be shaped so that a portion of each of the inserts is positioned between the mounting body and the wear body and engages both the wear body and the mounting body to help ensure the inserts are affixed to the crushing body.

In one exemplary embodiment, a method of making a crushing body comprises a first step of forming a wear body, a second step of forming a mounting body, a third step of positioning inserts in channels formed within the wear body, a fourth optional step of attaching a retaining member or fastener member to the wear body, a fifth step of positioning the mounting body adjacent to a base portion of each of the inserts, a sixth step of inserting fasteners in to the mounting body to connect the mounting body to at least one of the inserts and the wear body, and a seventh step of connecting the crushing body to a component of a crushing device so that the crushing body is connected to the frame of the crushing device. The channels may be formed when the wear body is formed or by drilling holes into the wear body after the wear body has been formed. The inserts may be positioned in sleeves and then the sleeves and inserts may be positioned in the channels. The fastener member may be formed into a portion of the wear body or the mounting body, or it may be formed as a separate component which is attached to the wear body. The fastener may receive a portion of each of the fasteners or some of the fasteners. Recesses or bosses may be provided to the mounting body to receive or support the base portions of the inserts.

In another exemplary embodiment, a method of making a crushing body comprises a first step of forming a wear body, a second step of forming a mounting body, a third step of attaching a fastener member between the wear body and the mounting body, a fourth step of inserting fasteners through the mounting body and into at least one of the fastening member and the wear body, and a fifth step of connecting the crushing body to a component of a crushing device so that the crushing body is connected to the frame of the crushing device. The fastening member may be manufactured to have projections that define one or more insert members. The one or more insert members may project into the wear body adjacent to an outer surface of the wear body to help define the crushing surface of the wear body. The method may further comprise extending some fasteners into the insert members of the fastening member and/or extending others through the fastening member and into the wear body. As will be understood by those of at least ordinary skill in the art, an embodiment of the crushing body may have any number of shapes or configurations to meet a particular design parameter or design objective. For example, the material properties of the wear body, mounting body, sleeve, fastening member, or inserts may vary to meet a design objective. Any number of metals may be used, such as steels comprising manganese, chromium, molybdenum, tungsten, carbon, alloys thereof, or other material for the composition of such components.

The shape, depth and positioning of the inserts, when used, may be any of a number of desired positions and configurations. Further, as indicated above, different embodiments of the crushing body may or may not utilize inserts, sleeves, or a fastening member. Embodiments of the crushing body may be sized and configured to effectively secure inserts or insert-like components in the wear surface of the crushing body via a combination of mechanical and chemical attachment mechanisms such as glue, welding, and the use of threaded fasteners so that the stability and life of the inserts may be longer and the crushing body may require less maintenance than conventional crushing bodies.

While certain present preferred embodiments of the crushing bodies, devices that include one or more of the crushing bodies, and methods of making and using the same have been shown and described above, it is to be distinctly understood that the invention is not limited thereto, but may be otherwise variously embodied and practiced within the scope of the following claims.

What is claimed is:

1. A method of making a crushing body for a crushing device comprising:
forming a wear body having a crushing surface;
forming a mounting body having a mounting surface which is complementary to a profile of the crushing device;
positioning inserts in the wear body;
providing fasteners to connect the mounting body to at least one of: the inserts and the wear body;
securing said inserts to at least one of the wear body and the mounting body.

2. The method of claim 1 wherein the inserts are harder or softer than the wear body.

3. The method of claim 1 wherein the mounting body engages a base portion of the inserts.

4. The method of claim 3 further comprising one of forming one or more recesses on the mounting body to receive base portions of the inserts and forming one or more bosses on the mounting body to support base portions of the inserts.

5. The method of claim 1 further comprising positioning sleeves in the wear body such that the inserts are at least partially surrounded by at least one respective sleeve and wherein one of: the sleeves are positioned with the inserts when the inserts are positioned in the wear body, the sleeves are positioned in the wear body before the inserts are positioned in the sleeves, and the sleeves are positioned in the wear body after the inserts are positioned in the wear body.

6. The method of claim 1 wherein the fasteners are separate fasteners having end portions which are received within at least one of the wear body and the inserts.

7. The method of claim 1 wherein the fasteners are separate retaining members inserted partially into or entirely through the mounting body until end portions of the fasteners abut base portions of the inserts.

8. The method of claim 1 further comprising welding, hot isostatic pressing or bonding the mounting body to the wear body.

9. The method of claim 1 wherein the crushing body is a roller, a sleeve, a segment of a roller, a segment of a sleeve, a crushing surface of a table, an anvil, a crushing surface of a jaw, a crushing surface of an anvil, a liner or mantle or a head of a crushing mechanism, or a portion of a liner or a mantle or a head of a crushing mechanism.

10. The method of claim 1 wherein the inserts are threaded and at least one of the wear body and the mounting body comprise threads which correspond to threads on the inserts.

11. The method of claim 1 wherein portions of the inserts are greater in width or diameter than other portions of the inserts.

12. The method of claim 1 wherein the mounting body and the wear body are inner and outer portions of an integrally-formed monolithic structure, respectively, and the fasteners secure the inserts to the structure.

13. The method of claim 1, further comprising providing one or more channels within the wear body and placing the inserts in said one or more channels.

14. A crushing body of a crushing device comprising:
a wear body having a crushing surface;
a mounting body having a mounting surface which is complementary to a profile of the crushing device;
a plurality of inserts at least partially positioned within the wear body and secured to the wear body;
a plurality of fasteners connecting the mounting body to at least one of: the inserts and the wear body.

15. The crushing body of claim 14 wherein the inserts are threaded and at least one of the wear body and the mounting body comprise threads which correspond to threads on the inserts.

16. The crushing body of claim 15 wherein said threads on the inserts are male threads, and wherein said plurality of fasteners comprises said male threads.

17. The crushing body of claim 15 wherein said threads on the inserts are female threads which are configured to receive corresponding male threads.

18. The crushing body of claim 14 wherein the inserts comprise portions which are greater in width or diameter than other portions of the inserts.

19. The crushing body of claim 14 wherein the fasteners are separate retaining members inserted partially into or entirely through the mounting body until end portions of the fasteners abut base portions of the inserts.

20. The crushing body of claim 14, further comprising one or more channels, voids, or recesses within the wear body which receive the inserts.

21. A crushing device comprising:
a frame;
at least one crushing body connected to the frame, the at least one crushing body comprising:
a wear body having channels,
a plurality of inserts at least partially positioned in the channels,
a mounting body adjacent the wear body and positioned adjacent to base portions of the inserts, and
a plurality of fasteners extending at least partially through the mounting body and into the inserts and/or the wear body.

22. The crushing device of claim 21 wherein the crushing device is a mill, a roller mill, a crusher, a gyratory crusher, a jaw crusher, or a cone crusher.
